(19) United States
(12) Patent Application Publication
(10) Pub. No.: US 2004/0131375 A1
(43) Pub. Date: Jul. 8, 2004

(54) Temperature control method for fusing device of an image forming apparatus

(75) Inventor: Beom-Ro Lee, Suwon city (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/732,249

(22) Filed: Dec. 11, 2003

(30) Foreign Application Priority Data
Jan. 7, 2003 (KR) 2003-895

(51) Int. Cl. G03G 15/20

(52) U.S. Cl. 399/69; 399/70

(57) ABSTRACT

A temperature control method for use in a fusing device of image forming apparatus having a fusing roller and a heater heating the fusing roller, including: sensing a surface temperature T of the fusing roller at one of when the image forming apparatus is turned on, when the image forming apparatus begins a normal operation from a power saving operation, and when a cover of the image forming apparatus is closed after being opened; comparing the sensed surface temperature T of the fusing roller with a set temperature; driving the heater until the surface temperature T reaches a first target temperature Tt₁ when the sensed surface temperature T is below the set temperature; and driving the heater until the surface temperature T reaches a second target temperature Tt₂ when the sensed surface temperature T is over the set temperature.

### CROSS-REFERENCE TO RELATED APPLICATIONS

This application claims the benefit of Korean Application No. 2003-895, filed Jan. 7, 2004, in the Korean Intellectual Property Office, the disclosure of which is incorporated herein by reference.

### BACKGROUND OF THE INVENTION

1. Field of the Invention

The present invention relates to fusing devices of image forming apparatus such as a laser beam printer, a multi-function machine, a photocopier, and the like, and more particularly, to a method of temperature control in a fusing device of an image forming apparatus by optimizing a power supply to a heater that heats a fusing roller of the fusing device and minimizing fluctuation in surface temperature of the fusing roller.

2. Description of the Related Art

Generally, an image forming apparatus such as a photocopier, a laser beam printer and the like, prints a desired image on a recording medium such as, a sheet of printing paper, by a series of image forming processes. The image forming processes include electrically charging a surface of a photosensitive drum by rotating an electrostatic charging roller disposed adjacent to the photosensitive drum, exposing the surface of the photosensitive drum to a laser beam projected from a laser scanning unit (LSU) to form an electrostatic latent image on the surface of the photosensitive drum, developing the electrostatic latent image formed on the surface of the photosensitive drum to a toner image of a powdery state (i.e. a powdery visible image) by supplying a toner to the surface of the photosensitive drum, transferring the toner image formed on the surface of the photosensitive drum onto the sheet of printing paper by passing the sheet between the photosensitive drum and a transfer roller which are in contact with each other under a pressure, by supplying a transfer voltage to the transfer roller and the photosensitive drum, and fusing the powdery toner image onto the sheet of printing paper by heating the sheet of printing paper with the toner image transferred thereon through a fusing device including a fusing roller.

Generally, in the process of fusing the toner image, a halogen lamp is employed as a heating source of the fusing device. The halogen lamp is disposed inside the fusing roller and/or a fusing backup roller to radiantly heat a surface of the fusing roller and/or the fusing backup roller to a temperature.

FIG. 1 schematically shows a conventional fusing device 10 of a conventional electrophotographic image forming apparatus.

The fusing device 10 includes a cylinder-shaped fusing roller 11 that has a non-stick coating layer of, for example, TEFLON® on a surface thereon, and a halogen lamp 12 disposed in an inner center thereof. The arrangement of the fusing roller 11 and the halogen lamp 12 is also shown in FIG. 2. The halogen lamp 12 generates heat inside of the fusing roller 11, and the fusing roller 11 is thereby heated by a radiant heat from the halogen lamp 12.

Returning to FIG. 1, disposed under the fusing roller 11 is a fusing backup roller 13. As shown in FIG. 3, the fusing backup roller 13 is resiliently supported by a spring 13a, so as to press a sheet of printing paper 14 passing between the fusing roller 11 and the fusing-backup roller 13, toward the fusing roller 11 with a pressure.

Accordingly, while the sheet of printing paper 14 is passing between the fusing roller 11 and the fusing backup roller 13, a toner image 14a formed on the sheet of printing paper 14 in the powdery state is subjected to a pressure and a heat. As a result, the toner image 14a is fused and fixed onto the sheet of printing paper 14 by the pressure and the heat imposed thereto through the fusing roller 11 and the fusing-backup roller 13.

Returning to FIG. 1, installed at a side of the fusing roller 11 are a thermistor 15, a thermostat 16 and a power switching part 19 such as a thyristor. The thermistor 15 is for detecting or sensing a surface temperature of the fusing roller 11 in an electric signal form, the thermostat 16 is for interrupting an electric power supply to the halogen lamp 12 when the surface temperature of the fusing roller 11 exceeds a given threshold, and the power switching part 19 is for switching a power supply of an AC power source 18 to the halogen lamp 12 according to a signal from a controller 20.

The thermistor 15 senses the surface temperature of the fusing roller 11, and transmits the sensed temperature to the controller 20. The controller 20 compares the sensed temperature with a set temperature, and regulates the power supply to the halogen lamp 12 through the power switching part 19, thereby maintaining the surface temperature of the fusing roller 11 in a print temperature suitable to fuse the toner image 14a and to fix it onto the sheet of printing paper 14.

The controller 20 usually controls the surface temperature of the fusing roller 11 by a temperature control process that includes an initial heating step of heating the surface temperature of the fusing roller 11 to a print standby temperature, a print standby step of maintaining the surface temperature of the fusing roller 11 at the print standby temperature and waiting a print command, and a printing step of maintaining the surface temperature of the fusing roller 11 higher than the print standby temperature to offset a loss in heat during the fusing operation of fusing the toner image.

At each of the operations of the temperature control process, the controller 20 controls the power supply to the halogen lamp 12, by comparing the sensed surface temperature of the fusing roller 11 with the set temperature and then turning on the halogen lamp 12 through the power switching part 19 when the detected temperature is below the set temperature and turning off the halogen lamp 12 when the detected temperature is over the set temperature, and thereby the surface temperature of the fusing roller 11 is maintained within a given range.

Also, the thermostat 16 functions as an overheating prevention means to protect the fusing roller 11 and its neighboring components, in case that the thermistor 15 and the controller 20 fail to regulate the surface temperature of the fusing roller 11.

However, the aforementioned fusing device is not without disadvantages. For example, in the conventional fusing device 10, since the halogen lamp 12 is turned on or off, regardless of a state or condition at each of the steps of the temperature control process for regulating the surface temperature of the fusing roller 11 in the print temperature, the electric power may not be efficiently supplied to the halogen lamp 12, thereby increasing power consumption and fluctuation in the surface temperature of the fusing roller 11 may be large.

When the fluctuation in the surface temperature of the fusing roller 11 is enlarged, the print temperature is unstably controlled, and thereby irregularly fusing the toner image onto the sheet of printing paper.

### SUMMARY OF THE INVENTION

The present invention has been developed in order to solve the above and/or other problems in the related art. Accordingly, it is an aspect of the present invention to provide a temperature control method for use in a fusing device of image forming apparatus, which is capable of stably fusing a toner image to fix it onto a recording medium such as a sheet of printing paper, by minimizing a fluctuation in a surface temperature of a fusing roller to stably maintain the surface temperature of the fusing roller.

It is another aspect of the present invention to provide a temperature control method for use in a fusing device of image forming apparatus, which is capable of optimizing a power supply to a heater that heats a fusing roller of the fusing device, thereby minimizing an amount of electric power which is supplied to the heater, as well as stably supplying it thereto.

Additional aspects and/or advantages of the invention will be set forth in part in the description which follows and, in part, will be obvious from the description, or may be learned by practice of the invention.

According to an embodiment of the present invention, there is provided a temperature control method for use in a fusing device of image forming apparatus having a fusing roller and a heater heating the fusing roller, including: sensing a surface temperature T of the fusing roller at one of when the image forming apparatus is turned on, when the image forming apparatus begins a normal operation from a power saving operation, and when a cover of the image forming apparatus is closed after being opened; comparing the sensed surface temperature T of the fusing roller with a set temperature; driving the heater until the surface temperature T reaches a first target temperature Tt₁ when the sensed surface temperature T is below the set temperature; and driving the heater until the surface temperature T reaches a second target temperature Tt₂ when the sensed surface temperature T is over the set temperature.

The operation of driving the heater until the surface temperature T reaches the second target temperature Tt₂ may include driving the heater for a first driving time or on-time calculated by the following formula every first control period T₁ where:

first on-time (ms)=T₁×(α₁×(T−Tt₂)+β₁)/100,

and where α1 is a first given proportional factor, and β₁ is a first offset value set according to the second target temperature Tt₂.

Here, the first offset value β₁ is set by a value, by which the surface temperature T of the fusing roller is maintainable at the second target temperature Tt₂when the heater is driven only for an on-time calculated by the formula of T₁×β₁/100 every first control period T₁ after the surface temperature of the fusing roller has reached the second target temperature Tt₂, or a value less than the value.

The method may further include a standing by operation by controlling the driving of the heater to maintain the surface temperature T at a third target temperature Tt₃ after the sensing, comparing and driving operations.

The print standby operation may include driving the heater for a second on-time calculated by the following formula every second control period T₂ to maintain the surface temperature T at a third target temperature Tt₃ where:

second on-time (ms)=T₂×(α₂×(T−Tt₃)+β₂)/100,

and where α₂ is a second given proportional factor, and β₂ is a second offset value set according to the third target temperature Tt₃.

At this time, the third target temperature Tt₃ is the print standby temperature described above, and is settable by the same temperature as the second target temperature Tt₂.

The second proportional factor α₂ may be determined by a rising slope in the surface temperature T of the fusing roller and the third target temperature Tt₃. Also, the second offset value β₂ may be one of a value V by which the surface temperature T of the fusing roller is maintained at the third target temperature Tt₃ when the heater is driven only for an on-time calculated by the following formula every second control period T₂, and a value less than the value V where:

on-time=T₂×β₂/100.

The method may further include printing by controlling the driving of the heater to maintain the surface temperature T at a fifth target temperature Tt₅ when a print command is input in the standing by operation.

The printing may include driving the heater until the surface temperature T reaches a fourth target temperature Tt4; and controlling the driving of the heater to maintain the surface temperature T at the fifth target temperature Tt5.

The operation of controlling the driving of the heater to maintain the surface temperature T at the fifth target temperature Tt₅ may include driving the heater when a surface temperature T of the fusing roller sensed every third control period T₃ is below the fifth target temperature Tt₅; and stopping the driving of the heater when the surface temperature T of the fusing roller sensed every third control period T₃ is over the fifth target temperature Tt₅.

During the stopping the driving of the heater, when the surface temperature T of the fusing roller is greater than fifth target temperature Tt₅, and the heater is driving and a heater driving time has not lapsed, the heater may be continuously driven until the heater driving time lapses. Also, the fourth target temperature Tt₄ may be one of the same temperature as the fifth target temperature Tt₅ and a temperature higher than the fifth target temperature Tt₅.

The method may further include saving power by carrying out a power saving operation when a print command is not input even though a standby time T₄ has lapsed in the standing by operation.

The method of power saving may include: determining whether the print command is input every fifth control period T₅ after a lapse of the standby time T₄; and controlling the driving of the heater to maintain the surface temperature T at a sixth target temperature Tt₆ when the print command is not input.

The operation of controlling the driving of the heater to maintain the surface temperature T at the sixth target temperature Tt₆ may include driving the heater for a third on-time calculated by the following formula every fourth control period T₅ where:

third on-time (ms)=T5×(α₃×(T−Tt₆)+β₃)/100,

and where α₃ is a third given proportional factor, and β3 is a third offset value set according to the sixth target temperature Tt₆.

The sixth target temperature Tt₆ is settable by an appropriate temperature below the third target temperature Tt₃ that is the print standby temperature.

Also, the third offset value β₃ is set by one of a value, by which the surface temperature T of the fusing roller can be maintained at the third target temperature Tt₃ when the heater is driven only for an on-time calculated by the formula of T₅×β₃/100 every fourth control period T₅ after the surface temperature T of the fusing roller has reached the sixth target temperature Tt₆, or a value less than the value.

Alternatively, the power saving can be composed of determining whether the print command is input after the lapse of the standby time T₄, and stopping the driving of the heater when the print command is not input.

According to another embodiment of the present invention, the fusing roller includes a rubber layer formed in a given thickness on a surface thereof.

A temperature control method of a fusion section of an image forming apparatus, including: raising the surface temperature of a fusion roller to a standby temperature which is close to a printing temperature; maintaining the standby temperature of the surface of the fusion roller after the raising; raising the surface temperature of the fusion roller to a printing temperature when a print command is received during the maintaining; and performing a power saving operation after a standby time has lapsed in the maintaining.

According to another aspect of the present invention, there is provided an image forming apparatus, including: a fusing roller; a heater disposed inside of the fusing roller and which increases a surface temperature of the fusing roller; and a control section including a sensor part which detects the surface temperature of the fusion roller and interrupts a power supply to the heater. The control section controls the surface temperature of a fusing roller by heating the surface according to a different algorithm for each of a warming-up, standing by, printing, and power saving operation of the image forming device so as to minimize surface temperature fluctuation and optimize power controlling a surface temperature of a fusing roller by heating the surface according to a different algorithm for each of a warming-up, standing by, printing, and power saving operation of the image forming device so as to minimize surface temperature fluctuation and optimize power supplied to perform the heating.

According to yet another embodiment of the present invention, there is provided a temperature control method including: initially heating a fusion roller of an image forming apparatus by increasing a surface temperature of the fusing roller to a temperature when the image forming apparatus is turned on; print standing by maintaining the increased surface temperature and waiting for a print command; and printing by increasing the surface temperature to a print temperature and fusing a toner image onto a sheet of printing paper. The initial heating, print standing by, and printing operations are each controlled according to a different temperature control algorithm.

### BRIEF DESCRIPTION OF THE DRAWINGS

These and other aspects and advantages of the invention will become apparent and more readily appreciated from the following description of the taken in conjunction with the accompanying drawings in which:

FIG. 1 is a schematic perspective view of a fusing device and a controller therefor in a conventional electrophotographic image forming apparatus;

FIG. 2 is a schematic cross-sectional view of a fusing roller and a heater of the fusing device shown of FIG. 1;

FIG. 3 is a schematic side elevation view of the fusing device shown of FIG. 1;

FIG. 4 is a cross-sectional view of a fusing roller and a heater in a fusing device to which a temperature control method according to an embodiment of the present invention is applied;

FIG. 5 is a flowchart illustrating a process of the temperature control method in accordance with an embodiment of the present invention;

FIG. 6 is a flowchart illustrating a process of an initial fusing roller-warming-up operation of the temperature control method in accordance with an embodiment of the present invention;

FIG. 7 is a flowchart illustrating a process of a print standby operation of the temperature control method in accordance with an embodiment of the present invention;

FIG. 8 is a flowchart illustrating a process of a printing operation of the temperature control method in accordance with an embodiment of the present invention;

FIG. 9 is a flowchart illustrating an example of a process of a power saving operation of the temperature control method in accordance with an embodiment of the present invention;

FIG. 10 is a flowchart illustrating another example of a process of the power saving operation of the temperature control method in accordance with an embodiment of the present invention; and

FIG. 11 is a graph illustrating surface temperatures of the fusing roller controlled according to the temperature control method in accordance with an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

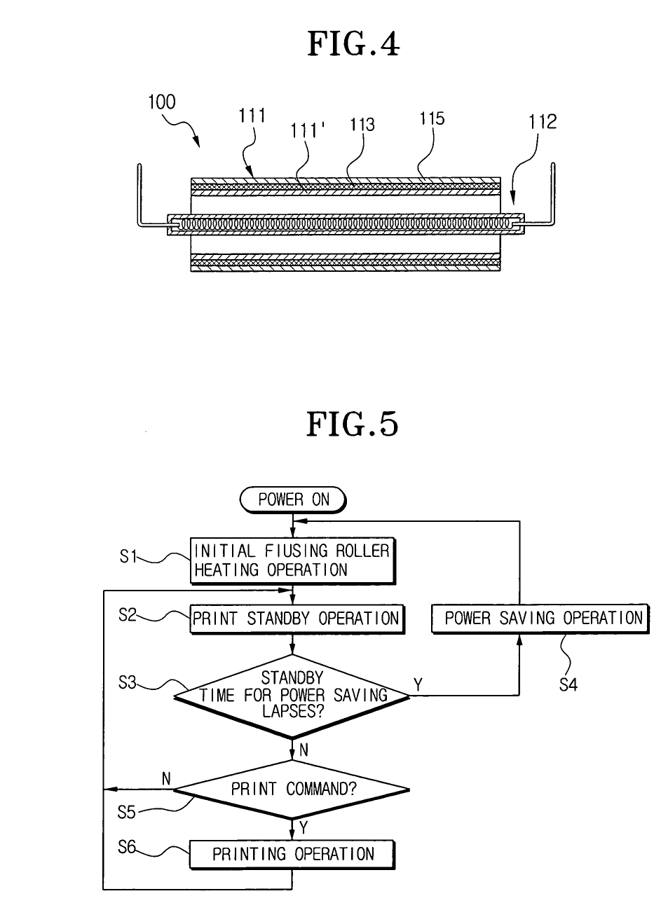

FIG. 4 schematically shows a part of a fusing device 100 of electrophotographic image forming apparatus, to which a temperature control method according to an embodiment of the present invention is applied.

The fusing device 100 includes a cylinder-shaped fusing roller 111 having a rubber layer on which a non-stick coating film 115, such as, by way of non-limiting example, TEFLON®, is coated, a fusing-backup roller (not shown) disposed under the fusing roller 111 to press the fusing roller 111 with a pressure, a heater 112, such as, by way of non-limiting example, a halogen lamp, is disposed in an inner center of the fusing roller 111 to generate a fusing heat for fusing a toner image and fixing it onto a sheet of printing paper inside the fusing roller 111, and a sensor part having a thermistor (not shown) and a thermostat (not shown) installed with respect to the fusing roller 111 respectively to detect a surface temperature of the fusing roller 111 and to interrupt an electric power supply to the heater 112 when the surface temperature of the fusing roller 111 exceeds a given threshold. The fusing device 100 also includes a controller (not shown) controlling an AC power supply to the heater 112 according to the surface temperature of the fusing roller 111, thereby to regulate an initial fusing roller-warming-up operation of heating the surface temperature of the fusing roller 111 to a print standby temperature, a standing by operation of maintaining the surface temperature of the fusing roller 111 at the print standby temperature and waiting a print command, a print operation of maintaining the surface temperature of the fusing roller 111 at a temperature higher than the print standby temperature to offset a loss in heat during a fusing operation, etc.

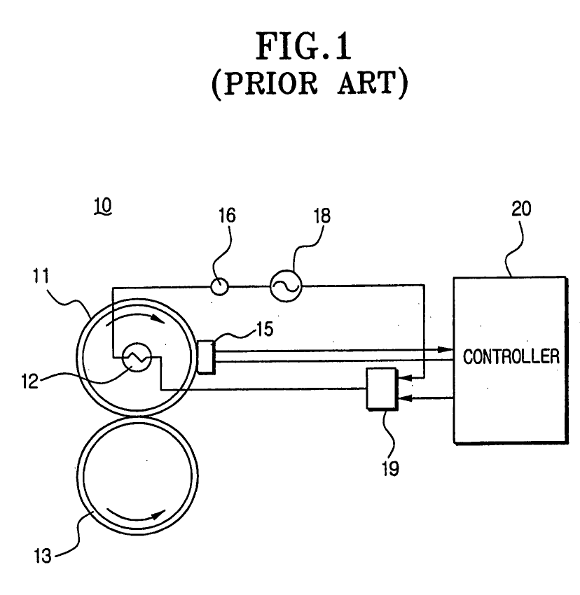

A description of the construction of the above elements except for the fusing roller 111 and the controller will be omitted here, as they are identical to those described above with reference to FIGS. 1, 2 and 3.

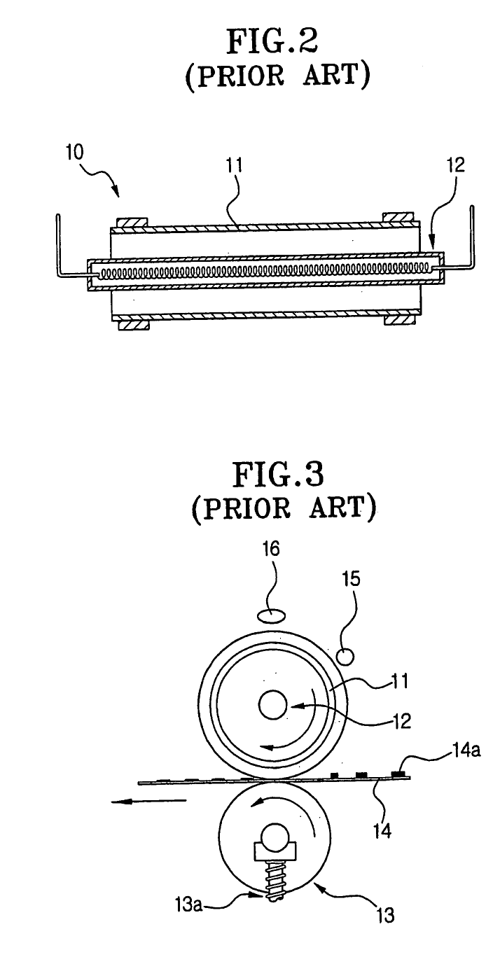

To supply a sufficient fusing heat to the toner image and the sheet of printing paper and increase a time on which the sheet of printing paper stays, the fusing roller 111 is formed of a cylinder-shaped aluminum roller having the rubber layer 113 which is TEFLON® coated or tubed on a surface thereof. Alternatively, the fusing roller 111 can use a cylinder-shaped aluminum roller having a coating layer coated or tubed with TEFLON® on a surface thereof, as the fusing device 10 shown in FIG. 2,

In the present embodiment, the fusing roller 111 has an aluminum cylinder 111′ formed in a thickness of about 1.5 mm, a rubber layer 113 formed in a thickness of about 1.5 mm on the aluminum cylinder, and a TEFLON® coating film 115 formed of a thickness of about 20-30 μm on the rubber layer 113. Also, the heater 112 uses 800 W at 220V. However, it is to be understood that other materials, thicknesses, and/or amounts are possible.

The temperature control method according to the present embodiment controls an optimum temperature by using a different algorithm for each of the operations such as the initial fusing roller-warming-up operation, the print standby operation, the printing operation, etc., thereby minimizing fluctuations in the surface temperature of the fusing roller and optimizing a power supply to the heater.

Hereinafter, descriptions will be made of operations about the temperature control method for use in the fusing device 100 of image forming apparatus according to an embodiment of the present invention with reference to FIG. 5 through FIG. 11.

First, when the image forming apparatus is turned on, as shown in FIG. 5, the controller carries out an initial fusing roller-warming-up operation (S1) to allow the fusing roller 111 to proceed with a fusing operation at any moment. As a result, a surface temperature T of the fusing roller 111 which is maintained at room temperature is increased to a third target temperature Tt₃ (i.e., a print standby temperature, for example 165° C.) close to a fifth target temperature Tt₅ (i.e., a print temperature, for example 180° C.).

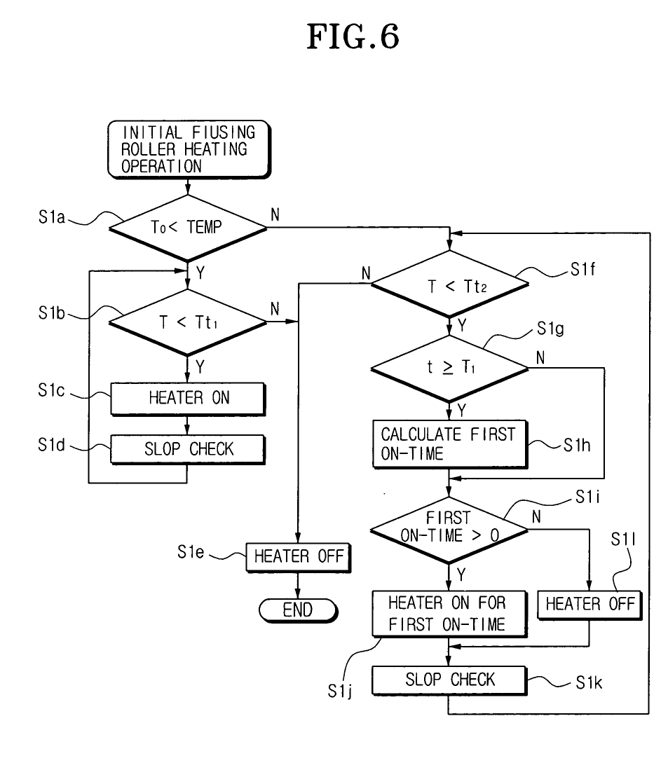

More specifically, as shown in FIG. 6, during a process of the initial fusing roller-warming-up operation (S1), the sensor part detects or senses an initial surface temperature T₀ of the fusing roller 111, and sends a signal corresponding to the sensed initial surface temperature T₀ to the controller, and then the controller compares the initial surface temperature T₀ obtained from the received signal with a set temperature Temp, for example 135° C. (S1a).

As a result of the comparison, when the sensed initial surface temperature T₀ is below the set temperature Temp, the controller continues to drive the heater 112 so as to increase the surface temperature T of the fusing roller 111 to a first target temperature Tt₁ in a short time (S1c), while determining whether the surface temperature T of the fusing roller 111 has reached the first target temperature Tt₁ (S1b). At this time, as shown in FIG. 11, the operation S1c carries out a phase control for a given initial time to minimize a fluctuation in voltage when an electric power is first supplied to the heater 112.

Subsequently, the controller checks a change slope in the surface temperature T of the fusing roller 111 to determine whether the sensor part is normally operated (S1d).

After that, when the surface temperature T reaches the first target temperature Tt₁, (i.e. when at operation S1b), the controller determines whether the surface temperature T has reached the first target temperature Tt₁, and the controller interrupts the electric power supply to the heater 112 to stop the driving of the heater 112 (S1e).

At this time, as shown in FIG. 11, the first target temperature Tt₁ is set at 155° C. The reason why the first target temperature Tt₁ is not set at 165° C. that is the print standby temperature Tt₃, but 155° C. is that if the heater is continuously driven at 165° C., the surface temperature T of the fusing roller 111 overshoots 165° C. To prevent such overshooting, the heater is driven at 155° C. (lower than 165° C.), and thereby the surface temperature T of the fusing roller 111 is increased to 165° C. by a heat capacity hitherto supplied.

Of course, if required, to supply a sufficient heat capacity to the fusing roller 111, the heater 112 will be continuously operated at 165° C., so that the surface temperature T of the fusing roller 111 overshoots 165° C.

On the other hand, as a result of the comparison at the operation S1a, when the sensed initial surface temperature T₀ is over the set temperature Temp, like when the image forming apparatus begins a normal operation from a power saving operation to be described later or when a cover of the image forming apparatus is closed after being opened for, by way of non-limiting example, maintenance and repair, if the heater 112 is continuously operated at 165° C. like as in the above operations (S1b-S1d), the surface temperature T of the fusing roller 111 overshoots the print standby temperature Tt₃. Accordingly, at this time, the controller repeatedly carries out the below operations (S1g-S1l) to calculate a heat capacity required to reach a second target temperature Tt₂, for example, 165° C., and then to drive the heater 112 for a required driving or on-time every a first control period T₁ until the surface temperature T of the fusing roller 111 reaches the second target temperature Tt₂, while determining whether the surface temperature T of the fusing roller 111 has reached the second target temperature Tt₂ (S1f).

More specifically, after determining whether the first control period T₁ has lapsed (S1g), the controller calculates a first on-time according to the following formula (1) when the first control period T₁ has lapsed (S1h):

first on-time (ms)=T₁×(α₁×(T−Tt₂)+β₁)/100 (1)

where α₁ is a first given proportional factor, and β₁ is a first offset value set according to the second target temperature Tt₂.

Here, the first control period T₁, the first proportional factor α₁, and the first offset value β₁ are set by values that yields an optimum first on-time. For example, the first offset value β₁ is set by a value by which the surface temperature T of the fusing roller 111 is maintainable at the second target temperature Tt₂ when the heater is driven only for an on-time calculated by the formula of T₁×β₁/100 every first control period T₁ after the surface temperature T of the fusing roller 111 has reached the second target temperature Tt₂, or a value less than the value.

Thereafter, the controller determines whether the first on-time still remains (S1i), drives the heater 112 (S1j) or stops the driving of the heater 112 (S1l), and then checks a change slope in the surface temperature T of the fusing roller 111 to determine whether the sensor part is normally operated (S1k).

Thus, after repeatedly carrying out operations (S1g-S1l), the controller blocks the electric power from being supplied to the heater 112 when at operation S1f, determining that the surface temperature T has reached the second target temperature Tt₂ (S1e), and thereby the initial fusing roller-warming-up operation S1 comes to an end.

The second target temperature Tt₂ is explained as being set to the third target temperature Tt₃, i.e., 165° C. equal to the print standby temperature, but it is settable by a temperature higher than the third target temperature Tt₃ to supply a sufficient heat capacity to the fusing roller 111 as described above, or a temperature lower than the third target temperature Tt₃ to proceed to the standing by operation more quickly.

Also, it is possible for the first proportional factor α₁ and the first offset value β₁ , to use a second proportional factor α₂ and a second offset value β₂ of the print standby operation which will be described, respectively. However, to allow the surface temperature T to reach the second target temperature Tt₂ more quickly, the first proportional factor α₁ is settable to a higher value.

Of course, the first control period T₁ can also use a second control period T₂ of the print standby operation, but since the second control period T₂ has a large period of 30˜40 sec, it uses a value smaller than the second control period T₂.

Referring again to FIG. 5, after the initial fusing roller-warming-up operation S1, the controller carries out a print standby operation S2 to maintain the surface temperature T of the fusing roller 111 at the print standby temperature, (i.e., the third target temperature Tt₃), and thereby allowing the fusing roller 111 to proceed with the fusing operation at any moment.

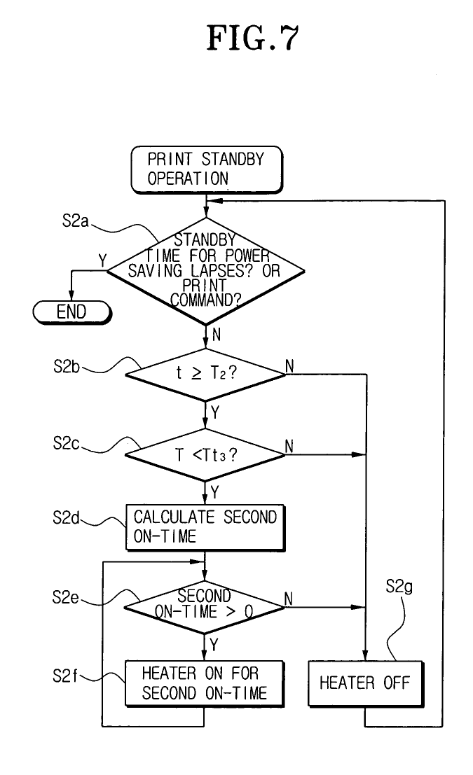

That is to say, as shown in FIG. 7 illustrating a process of the print standby operation S2, the controller determines whether a standby time T₄ for power saving has lapsed (S3), or whether a print command is input (S5) as shown in FIG. 5 (S2a), and when the standby time T₄ has not lapsed and the print command is not input, repeatedly carries out the below operations (S2b-S2g) to calculate a heat capacity required to reach the third target temperature Tt₃, i.e. the print standby temperature (165° C.; FIG. 11) and then to drive the heater 112 for a required on-time every second control period T₂ until the surface temperature T of the fusing roller 111 reaches the third target temperature Tt₃.

More specifically, after determining whether the second control period T₂ has lapsed (S2b), the controller determines whether the surface temperature T of the fusing roller 111 is over the third target temperature Tt₃ when the second control period T₂ has lapsed (S2c).

As a result of the decision, when the surface temperature T of the fusing roller 111 is below the third target temperature Tt₃, the controller calculates a second on-time according to the following formula (2) (S2d):

second on-time (ms)=T₂×(α₂×(T−Tt₃)+β₂)/100 (2)

where α₂ is a second given proportional factor, and β₂ is a second offset value set according to the third target temperature Tt₃.

At this time, the second proportional factor α₂ is determined by a rising slope in the surface temperature T of the fusing roller 111 and the third target temperature Tt₃, and the second offset value β₂ is set by a value by which the surface temperature T of the fusing roller 111 is maintainable at the third target temperature Tt₃ when the heater 112 is driven only for an on-time calculated by the formula of T₂×β₂/100 every second control period T₂ after the surface temperature T of the fusing roller has reached the third target temperature Tt₃, or a value less than the value.

Thereafter, the controller determines whether the second on-time still remains (S2e), and drives the heater 112 (S2f) or stops the driving of the heater 112 (S2g) according to the remaining second on-time.

Thus, after repeatedly carrying out operations (S2b-S2g), the controller ends the print standby operation S2 when at the operation S2a, the standby time T₄ has lapsed or the print command is input.

At this time, at the operation S2a, as shown in FIG. 5, if the print command is input, the controller carries out the print operation S6 to control the driving of the heater 112 so as to maintain the surface temperature T of the fusing roller 111 at a fifth target temperature Tt₅, i.e. the print temperature of 180° C. as illustrated in FIG. 11.

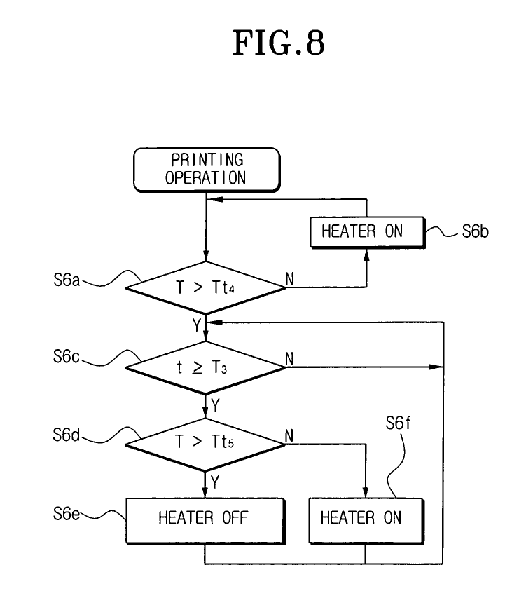

As shown in FIG. 8 illustrating a process of the print operation S6, at the print operation S6, the controller first determines whether the surface temperature T of the fusing roller 111 has reached a fourth target temperature Tt₄, for example an appropriate temperature below 180° C. (S6a). As a result of the decision, when the surface temperature T is below the fourth target temperature Tt₄, the controller continues to drive the heater 112 (S6b), whereas when the surface temperature T is over the fourth target temperature Tt₄, repeatedly carries out the below operations (S6c-S6f) every a third control period T₃, for example a period of time at which the sheet of printing paper stays on the fusing roller 111 or 1/n of printing time, in order to maintain the surface temperature T at the fifth target temperature Tt₅.

That is to say, after determining whether a time corresponding to the third control period T₃ has lapsed (S6c), the controller determines whether the surface temperature T of the fusing roller 111 is over the fifth target temperature Tt₅ when the time corresponding to the third control period T₃ has lapsed (S6d).

As a result of the decision, when the surface temperature T of the fusing roller 111 is over the fifth target temperature Tt₅, the controller stops the driving of the heater 112 (S6e), and when the surface temperature T of the fusing roller 111 is below the fifth target temperature Tt₅, it continues to drive the heater 112 (S6f).

At the operation S6e, when the surface temperature T of the fusing roller is over the fifth target temperature Tt₅, but the heater 112 is driving and the time corresponding to the third control period T₃ does not lapse, the heater is continuously driven until the time corresponding to the third control period T₃ lapses.

These operations (S6c-S6f) are repeated until a printing operation comes to an end.

Thus, when the printing operation is ended, the controller again carries out the print standby operation S2 to maintain the surface temperature T of the fusing roller 111 at the third target temperature Tt₃, i.e., the print standby temperature.

At this time, after the printing operation is ended, if the heater 112 is driving and there is no print command for a next sheet of printing paper, the controller stops the driving of the heater 112, since if the heater 112 is continuously driven, the surface temperature T of the fusing roller 111 is overshot for a time corresponding to the beginning of the second control period T₂ that starts to regulate it in the print standby temperature Tt₃.

On the other hand, at operation S2a of the print standby operation S2, as shown in FIG. 5, when the print command is not input even though the standby time T₄ for power saving has lapsed, the controller carries out the power saving operation S4.

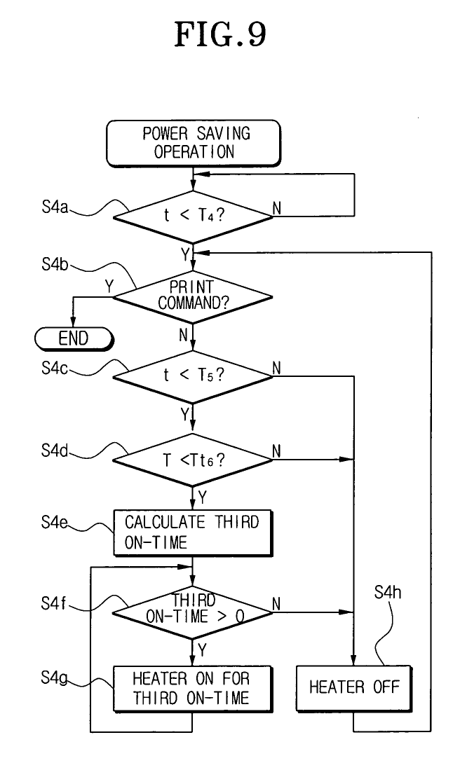

More specifically, as shown in FIG. 9 illustrating an example of a process of the power saving operation S4, the controller determines whether the standby time T₄ has lapsed (S4a), and when the standby time T₄ has lapsed, determines whether the print command is input (S4b).

As a result of the decision at the operation S4b, when the print command is not input, the controller repeatedly carries out the below operations (S4c-S4h) to calculate a heat capacity required to maintain the surface temperature T of the fusing roller 111 at a sixth target temperature Tt₆, i.e., a power saving temperature (for example a temperature below 165° C.) and then to drive the heater 112 for a required driving or on-time every a fourth control period T₅.

That is to say, after determining whether the fourth control period T₅ has lapsed (S4c), the controller determines whether the surface temperature T of the fusing roller 111 is over the sixth target temperature Tt₆ when the fourth control period T₅ has lapsed (S4d).

As a result of the decision, when the surface temperature T of the fusing roller 111 is below the sixth target temperature Tt₆, the controller calculates a third on-time according to the following formula (3) (S4e):

third on-time (ms)=T₅×{α₃×(T−Tt₆)+β₃}/100 (3)

where α₃ is a third given proportional factor and β₃ is a third offset value set according to the sixth target temperature Tt₆.

At this time, the third proportional factor α₃, and the third offset value β₃ are set by values that can obtain an optimum third on-time. For example, the third offset value β₃ is set by a value by which the surface temperature T of the fusing roller 111 is maintainable at the sixth target temperature Tt₆ when the heater is driven only for an on-time calculated by the formula of T₅×β₃/100 every fourth control period T₅ after the surface temperature T of the fusing roller 111 has reached the sixth target temperature Tt₆, or a value less than the value.

Thereafter, the controller determines whether the third on-time still remains (S4f), and drives the heater 112 (S4g) or stops the driving of the heater 112 (S4h) according to the left third on-time.

Thus, after repeatedly carrying out operations (S4c-S4h), the controller ends the power saving operation S4 when at operation S4b, the print command is input, and again moves to the initial fusing roller-warming-up operation S1 to repeat operations explained above.

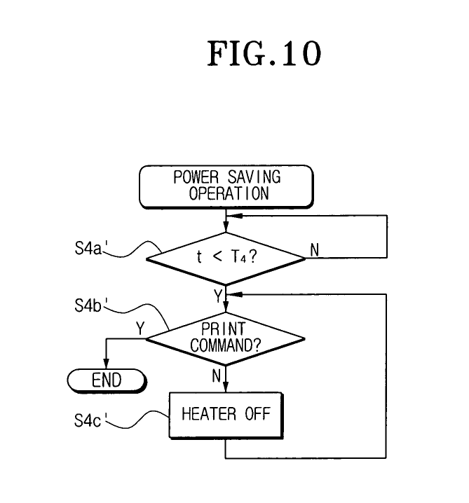

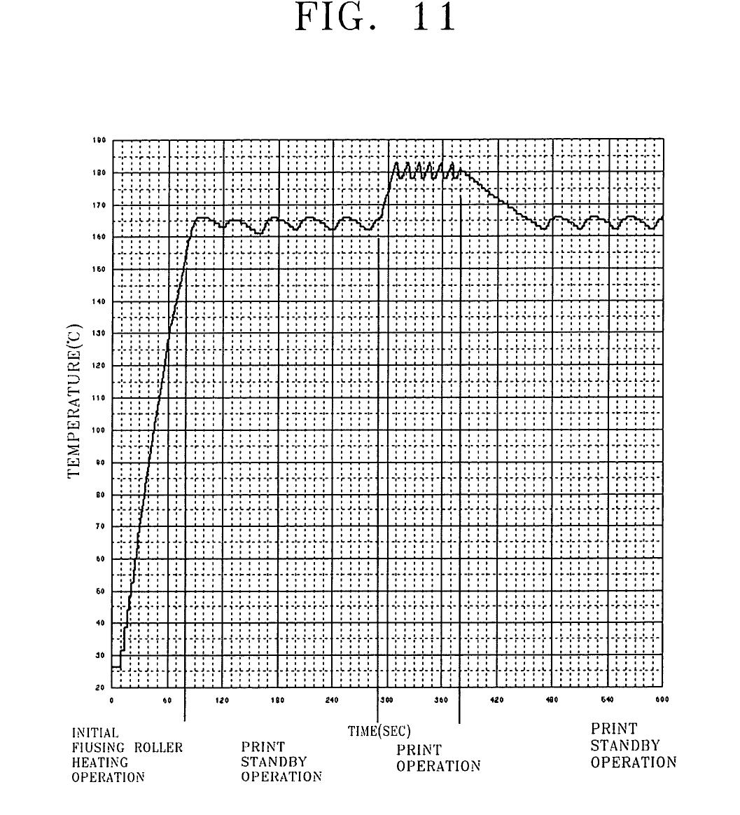

Alternatively, as shown in FIG. 10 illustrating another example of the process of the power saving operation S4, the power saving operation S4 is performable by determining whether the standby time T₄ has lapsed (S4a′), determining whether the print command is input when the standby time T₄ has lapsed (S4b′), and then stopping the driving of the heater 112 when the print command is not input.

As described so far, it will be appreciated that the temperature control method for use in the fusing device according to the present invention provides an effect that minimizes the fluctuation in the surface temperature of the fusing roller and optimizes the AC power supply to the heater, by controlling the optimum temperature by using the different algorithm for each of operations such as the initial fusing roller-warming-up operation, the print standby operation, the printing operation, and the power saving operation.

Although a few preferred embodiments of the present invention have been shown and described, the present invention is not limited to the disclosed embodiments. Rather, it would be appreciated by those skilled in the art that changes may be made in this embodiment without departing from the principles and spirit of the invention, the scope of which is defined in the claims and their equivalents.

What is claimed is:

1. A temperature control method for use in a fusing device of image forming apparatus having a fusing roller and a heater heating the fusing roller, comprising:
sensing a surface temperature T of the fusing roller at one of when the image forming apparatus is turned on, when the image forming apparatus begins a normal operation from a power saving operation, and when a cover of the image forming apparatus is closed after being opened;
comparing the sensed surface temperature T of the fusing roller with a set temperature;
driving the heater until the surface temperature T reaches a first target temperature Tt₁ when the sensed surface temperature T is below the set temperature; and
driving the heater until the surface temperature T reaches a second target temperature Tt₂ when the sensed surface temperature T is over the set temperature.

2. The method of claim 1, wherein the driving the heater until the surface temperature T reaches the second target temperature Tt₂ includes driving the heater for a first on-time calculated by the following formula every first control period T₁, wherein:
first on-time (ms)=T₁×(α₁×(T−Tt₂)+β₁)/100,
and wherein α₁ is a first proportional factor and β₁ is a first offset value set according to the second target temperature Tt₂.

3. The method of claim 2, wherein the first proportional factor α₁ is determined by the second target temperature Tt₂ and a rising slope in the surface temperature T of the fusing roller.

4. The method of claim 2, wherein the first offset value β₁ is settable by a first value, by which the surface temperature T of the fusing roller is maintainable at the second target temperature Tt₂ when the heater is driven only for an on-time calculated by the formula of T₁×β₁/100 every first control period T₁ after the surface temperature of the fusing roller has reached the second target temperature Tt₂, and a second value less than the first value.

5. The method of claim 1, further comprising standing by by controlling the driving of the heater to maintain the surface temperature T at a third target temperature Tt₃ after the sensing, comparing and driving operations.

6. The method of claim 5, wherein the standing by includes driving the heater for a second on-time calculated by the following formula every second control period T₂ to maintain the surface temperature T at the third target temperature Tt₃, wherein:
second on-time (ms)=T₂×(α₂×(T−Tt₃)+β₂)/100,
and wherein α₂ is a second given proportional factor and β₂ is a second offset value set according to the third target temperature Tt₃.

7. The method of claim 6, wherein the second proportional factor α₂ is determined by the third target temperature Tt₃ and a rising slope in the surface temperature T of the fusing roller.

8. The method of claim 6, wherein the second offset value β₂ is one of a value V by which the surface temperature T of the fusing roller is maintained at the third target temperature Tt₃ when the heater is driven only for an on-time calculated by the following formula every second control period T₂, and a value less than the value V, wherein:
on-time=T₂×β₂/100.

9. The method of claim 1, wherein the first target temperature Tt₁ is one of a temperature Tᵥ so that the surface temperature T of the fusing roller is increasable to the third target temperature Tt₃ when the heater is turned off after heating the surface temperature T of the fusing roller to the first target temperature Tt₁, and a temperature higher than the temperature Tᵥ.

10. The method of claim 1, wherein the second target temperature Tt₂ is the same temperature as the third target temperature Tt₃, the third target temperature Tt₃ being a print standby temperature.

11. The method of claim 2, wherein the first proportional factor α₁ is one of the same value as the second proportional factor α₂ and a value larger than the value of the second proportional factor α₂.

12. The method of claim 5, further comprising printing by controlling the driving of the heater to maintain the surface temperature T at a fifth target temperature Tt₅ when a print command is input in the standing by.

13. The method of claim 12, wherein the printing comprises:
driving the heater until the surface temperature T reaches a fourth target temperature Tt₄; and
controlling the driving of the heater to maintain the surface temperature T at the fifth target temperature Tt₅.

14. The method of claim 13, wherein the operation of controlling the driving of the heater to maintain the surface temperature T at the fifth target temperature Tt₅ comprises:
driving the heater when a surface temperature T of the fusing roller sensed every third control period T₃ is below the fifth target temperature Tt₅; and
stopping the driving of the heater when the surface temperature T of the fusing roller sensed every third control period T₃ is over the fifth target temperature Tt₅.

15. The method of claim 14, wherein in the stopping the driving of the heater, when the surface temperature T of the fusing roller is greater than fifth target temperature Tt₅, and the heater is driving and a heater driving time has not lapsed, the heater is continuously driven until the heater driving time lapses.

16. The method of claim 13, wherein the fourth target temperature Tt₄ is one of the same temperature as the fifth target temperature Tt₅ and a temperature higher than the fifth target temperature Tt₅.

17. The method of claim 5, further comprising saving power by carrying out a power saving operation when a print command is not input even though a standby time T₄ has lapsed in the standing by.

18. The method of claim 17, wherein the power saving comprises:
determining whether the print command is input every fifth control period T₅ after a lapse of the standby time T₄; and
controlling the driving of the heater to maintain the surface temperature T at a sixth target temperature Tt₆ when the print command is not input.

19. The method of claim 18, wherein the controlling the driving of the heater to maintain the surface temperature T at the sixth target temperature Tt₆ comprises driving the heater for a third on-time calculated by the following formula every fourth control period T₅, wherein:
third on-time (ms)=T₅×(α₃×(T−Tt₆)+β₃₎/100,
and wherein α₃ is a third given proportional factor and β₃ is a third offset value set according to the sixth target temperature Tt₆.

20. The method of claim 19, wherein the sixth target temperature Tt₆ is settable by an appropriate temperature below the third target temperature Tt₃ that is a print standby temperature.

21. The method of claim 17, wherein the power saving comprises:
determining whether the print command is input after a lapse of the standby time T₄; and
stopping the driving of the heater when the print command is not input.

22. The method of claim 1, wherein the fusing roller comprises a rubber layer formed in a given thickness on a surface thereof.

23. The method of claim 6, wherein the third target temperature Tt₃ is the print standby temperature and is settable by the same temperature as the second target temperature Tt₂.

24. The method of claim 19, wherein the third offset value β₃ is settable by one of a first value, by which the surface temperature T of the fusing roller is maintainable at the third target temperature Tt₃ when the heater is driven only for an on-time calculated by the formula of T₅×β₃/100 every fourth control period T₅ after the surface temperature T of the fusing roller has reached the sixth target temperature Tt₆, and a second value less than the first value.

25. The method of claim 18, wherein the power saving includes determining whether the print command is input after the lapse of the standby time T₄, and stopping the driving of the heater when the print command is not input.

26. A temperature control method of a fusion section of an image forming apparatus, comprising:
raising the surface temperature of a fusion roller to a standby temperature which is close to a printing temperature;
maintaining the standby temperature of the surface of the fusion roller after the raising;
raising the surface temperature of the fusion roller to a printing temperature when a print command is received during the maintaining; and
performing a power saving operation after a standby time has lapsed in the maintaining.

27. The method of claim 26, wherein the raising the surface temperature of a fusion roller to a standby temperature comprises:
sensing an initial surface temperature of the fusion roller;
comparing the sensed initial surface temperature to a reference temperature to determine if the sensed initial surface temperature is below the reference temperature;
heating the surface of the fusion roller to a first target temperature when the initial surface temperature is less than the reference temperature; and
heating the surface of the fusion roller to a second target temperature when the initial surface temperature is greater than the reference temperature.

28. The method of claim 27, wherein the heating the surface of the fusion roller to a second target temperature includes driving a heater only for a time calculated according to the following equation every period T₁:
T₁×(α₁×(T−Tt₂)+β₁)/100,
wherein α₁ is a first given proportional factor and β₁ is a first offset value set according to the second target temperature.

29. The method of claim 26, wherein the maintaining includes driving a heater only for a time calculated according to the following equation every period T₂:
T₂×(α₂×(T−Tt₃)+β₂)/100,
wherein α₂ is a second given proportional factor and β₂ is a second offset value set according to the third target temperature.

30. The method of claim 26, wherein the raising the surface temperature of the fusion roller to a printing temperature comprises:
heating the surface of the fusion roller with a heater; and
maintaining the printing temperature of the surface of the fusion roller.

31. The method of claim 30, wherein the maintaining the printing temperature of the surface of the fusion roller comprises
sensing the surface temperature of the fusion roller every control period;
driving the heater when a surface temperature of the fusing roller is below the printing temperature; and
stopping the driving of the heater when the surface temperature of the fusing roller is greater than the printing temperature.

32. The method of claim 31, wherein the heater is continuously driven until a heater driving time lapses, even when the surface temperature of the fusion roller is greater than the printing temperature.

33. The method of claim 26, wherein the power saving comprises:
periodically determining whether a print command is received after the standby time has lapsed;
heating the surface of the fusion roller to a power saving temperature; and
maintaining the power saving temperature.

34. The method of claim 33, wherein the maintaining the power saving temperature includes driving the heater only for a time calculated every period T₅:
T₅×(α₃×(T−Tt₆)+β₃}/100,
wherein α₃ is a third given proportional factor and β₃ is a third offset value set according to the power saving temperature.

35. A temperature control method of a fusing device of an image forming device, comprising:
controlling a surface temperature of a fusing roller by heating the surface according to a different algorithm for each of a warming-up, standing by, printing, and power saving operation of the image forming device so as to minimize surface temperature fluctuation and optimize power supplied to perform the heating.

36. An image forming apparatus, comprising:
a fusing roller;
a heater disposed inside of the fusing roller and which increases a surface temperature of the fusing roller; and
a control section including a sensor part which detects the surface temperature of the fusion roller and interrupts a power supply to the heater,
wherein the control section controls the surface temperature of a fusing roller by heating the surface according to a different algorithm for each of a warming-up, standing by, printing, and power saving operation of the image forming device so as to minimize surface temperature fluctuation and optimize power controlling a surface temperature of a fusing roller by heating the surface according to a different algorithm for each of a warming-up, standing by, printing, and power saving operation of the image forming device so as to minimize surface temperature fluctuation and optimize power supplied to perform the heating.

37. The apparatus of claim 36, wherein the fusion roller is coated with a non-stick material.

38. The apparatus of claim 36, wherein the heater is a halogen lamp.

39. The apparatus of claim 36, wherein the sensor part includes:
a thermistor which detects the surface temperature of the fusion roller;
a thermostat which interrupts the power supply to the heater when the detected surface temperature exceeds a threshold; and
a controller which controls the supply of power to the heater according to the detected surface temperature of the fusion roller.

40. A temperature control method comprising:
initially heating a fusion roller of an image forming apparatus by increasing a surface temperature of the fusing roller to a temperature when the image forming apparatus is turned on;
print standing by maintaining the increased surface temperature and waiting for a print command; and
printing by increasing the surface temperature to a print temperature and fusing a toner image onto a sheet of printing paper,
wherein the initial heating, print standing by, and printing operations are each controlled according to a different temperature control algorithm.

41. The method of claim 40, wherein, in the print standing by, the surface temperature of the fusing roller is maintained at a lowest temperature by which the fusing roller is able to reach the print temperature when the sheet of printing paper arrives at the fusing roller after input of the print command.

42. The method of claim 40, wherein, in the printing, the surface temperature of the fusing roller is increased to the print temperature as soon as possible after an input of the print command, and maintained within a permitted range even when the sheet of printing paper passes through the fusing roller.

43. The method of 40, wherein, in the initial heating, the heater is driven until the surface temperature T of the fusing roller reaches a first target temperature Tt₁ when the image forming apparatus is turned on.

44. The method of 40, wherein the first target temperature Tt₁ is set by the same temperature as a surface temperature of the fusing roller that is maintained at the print standby temperature.
